(19) United States
(12) Patent Application Publication
(10) Pub. No.: US 2026/0151961 A1
(43) Pub. Date: Jun. 4, 2026

(54) THREE-DIMENSIONAL MOLDING DEVICE

(71) Applicant: SEIKO EPSON CORPORATION, Tokyo (JP)

(72) Inventor: Eiji OKAMOTO, MATSUMOTO-SHI (JP)

(21) Appl. No.: 19/400,045

(22) Filed: Nov. 25, 2025

(30) Foreign Application Priority Data
Nov. 29, 2024 (JP) 2024-208284

(51) Int. Cl. B29C 64/336; B29C 64/106; B29C 64/209; B29K 101/12; B29K 105/06; B33Y 30/00

(52) U.S. Cl. CPC B29C 64/336; B29C 64/209; B33Y 30/00; B29C 64/106; B29K 2101/12; B29K 2105/06

(57) ABSTRACT

A three-dimensional molding device includes a plasticizing section, a fiber material supply section, a first communication path through which the molten material passes, a second communication path through which the fiber material passes, a flow path configured to allow passage of the molten material that has passed through the first communication path and the fiber material that has passed through the second communication path, a material switching section that controls communication among the first communication path, the second communication path, and the flow path; a nozzle that ejects the molten material and the fiber material that have passed through the flow path, and a control section, wherein the control section controls the material switching section to switch among multiple modes.

The present application is based on, and claims priority from JP Application Serial Number 2024-208284, filed Nov. 29, 2024, the disclosure of which is hereby incorporated by reference herein in its entirety.

### BACKGROUND

### 1. Technical Field

The present disclosure relates to a three-dimensional molding device.

### 2. Related Art

The disclosure in JP-A-2022-131037 discloses a three-dimensional molding device that introduces, into a molten material containing a first fiber material and a thermoplastic resin, a second fiber material, which is longer than the first fiber material, and that forms a three-dimensional molded object containing both the first and second fiber materials.

In the three-dimensional molding device, switching between ejection of the molten material and ejection of the fiber material from the nozzle has not been considered.

### SUMMARY

According to a first aspect of the present disclosure, a three-dimensional molding device is provided. The three-dimensional molding device includes a plasticizing section configured to plasticize at least a portion of a material containing thermoplastic resin to generate molten material; a fiber material supply section configured to supply fiber material; a first communication path communicating with the plasticizing section and configured to allow the molten material to pass through; a second communication path communicating with the fiber material supply section and configured to allow the fiber material to pass through; a flow path configured to allow passage of the molten material that passed through the first communication path and the fiber material that passed through the second communication path; a material switching section connected to the first communication path, to the second communication path, and to the flow path, and configured to switch communication state of the first communication path, the second communication path, and the flow path; a nozzle that communicates with the flow path and that ejects the molten material and the fiber material that passed through the flow path onto a stage; and a control section configured to control the plasticizing section, the fiber material supply section, and the material switching section to form a three-dimensional molded object including the molten material on the stage; wherein the control section is configured to control the material switching section to switch among a first mode in which the first communication path is in communication with the flow path and the second communication path is not in communication with the flow path; a second mode in which the second communication path is in communication with the flow path and the first communication path is not in communication with the flow path; a third mode in which both the first communication path and the second communication path are in communication with the flow path; a fourth mode in which neither the first communication path nor the second communication path is in communication with the flow path.

### BRIEF DESCRIPTION OF THE DRAWINGS

FIG. 1 is an explanatory diagram illustrating a schematic configuration of a three-dimensional molding device according to a first embodiment.

FIG. 2 is an explanatory diagram illustrating a schematic configuration of a molding section.

FIG. 3 is a perspective view showing a schematic configuration of a flat screw.

FIG. 4 is a schematic plan view of a barrel.

FIG. 5 is a perspective view of a rotating member.

FIG. 6 is a diagram for explaining an angular position of a rotating member around a rotation axis in a first mode.

FIG. 7 is a diagram for explaining an angular position of a rotating member around a rotation axis in a second mode.

FIG. 8 is a diagram for explaining an angular position of the rotating member around a rotation axis in the third mode.

FIG. 9 is a diagram for explaining an angular position of the rotating member around a rotation axis in a fourth mode.

FIG. 10 is an explanatory diagram illustrating an example of a schematic configuration of a molding section according to another embodiment.

### DESCRIPTION OF EMBODIMENTS

### A. First Embodiment

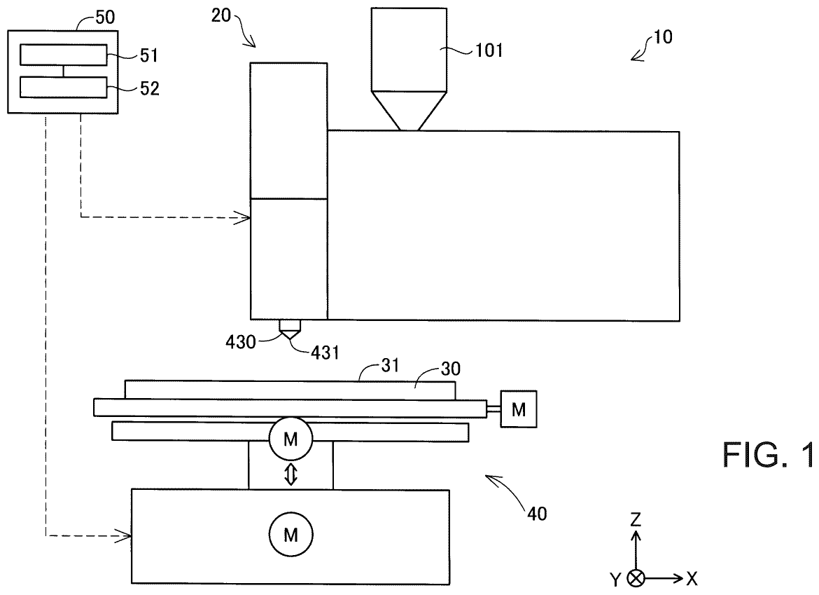

FIG. 1 is an explanatory view showing a schematic configuration of a three-dimensional molding device 10 in a first embodiment. In FIG. 1, arrows indicating X, Y, and Z directions orthogonal to each other are shown. The X direction and the Y direction are directions parallel to a horizontal plane. The Z direction is a direction parallel to the vertical direction. The X, Y, and Z directions in FIG. 1 and the X, Y, and Z directions in other drawings indicate the same directions. When a direction is specified, positive and negative signs are used together with the direction notation, wherein the positive direction, which is the direction indicated by the arrow, is “+” and the negative direction, which is the direction opposite to the direction indicated by the arrow, is “−”. The +Z direction is also referred to as “up”, and the −Z direction is also referred to as “down”.

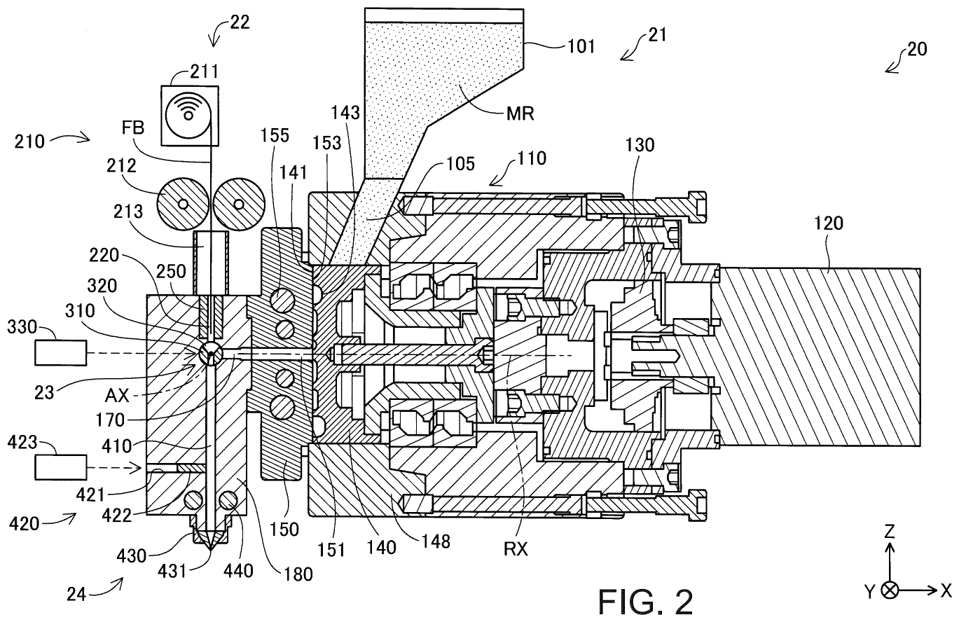

The three-dimensional molding device 10 is a device that molds a three-dimensional molded object by a material discharge method. The three-dimensional molding device 10 includes a molding section 20 that generates and ejects a molten material, a molding stage 30 serving as a base stage of a three-dimensional molded object, a movement mechanism 40 that controls an ejection position of the molten material, and a control section 50 that controls each section of the three-dimensional molding device 10. FIG. 2 is an explanatory diagram illustrating a schematic configuration of the molding section 20. Hereinafter, each section of the three-dimensional molding device 10 will be described with reference to FIGS. 1 and 2.

The molding section 20 ejects a molten material obtained by plasticizing a material in a solid state onto the stage 30 under the control of the control section 50. The molding section 20 includes a molten material introduction section 21, a fiber material introduction section 22, a material switching section 23, and a ejection section 24.

The molten material introduction section 21 generates a molten material and guides the generated molten material to the material switching section 23. The molten material introduction section 21 includes a material supply section 101, a plasticizing section 110, and a first communication path 170.

The material supply section 101 supplies the material MR to the plasticizing section 110. The material supply section 101 is configured by, for example, a hopper that accommodates the material MR. The material supply section 101 is connected to the plasticizing section 110 via a material supply path 105. The material MR is put in the material supply section 101 in the form of pellets, powder, or the like. As the material MR, for example, thermoplastic resin such as acrylonitrile butadiene styrene (ABS), polyether ether ketone (PEEK), polypropylene (PP) or the like, is used. The material MR may include inorganic material such as metal or ceramic.

The plasticizing section 110 generates a pasty molten material in which fluidity is expressed by plasticizing at least a portion of the material MR supplied from the material supply section 101. In the present embodiment, “plasticization” means a concept including melting, and means a change from a solid state to a fluid state. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point. The plasticizing section 110 includes a drive motor 120, a decelerator 130, a flat screw 140, and a barrel 150. The flat screw 140 is also referred to as a rotor, a scroll, or simply a screw. The barrel 150 is also called a screw facing section.

The flat screw 140 is housed in a screw case 148. The flat screw 140 is connected to the drive motor 120 via the decelerator 130, and rotates about the rotation axis RX in the screw case 148 by a rotational driving force generated by the drive motor 120. In the present embodiment, the direction of the rotation axis RX is along the X direction.

The rotation of the flat screw 140 by the drive motor 120 is controlled by the control section 50. The barrel 150 is arranged on the-X direction side of the flat screw 140.

The flat screw 140 may be directly coupled to the drive motor 120 without the decelerator 130.

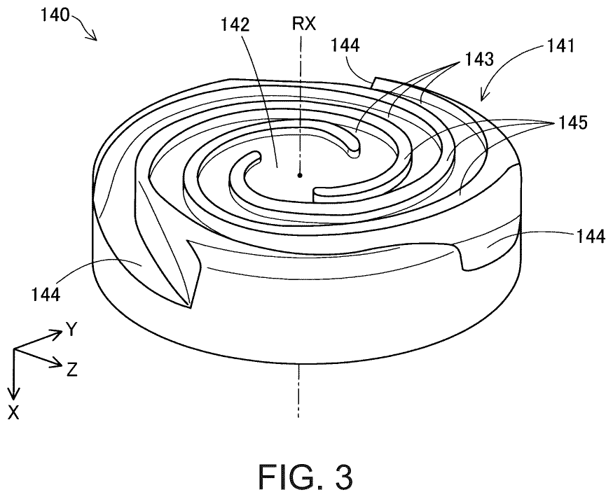

FIG. 3 is a perspective view showing a schematic configuration of the flat screw 140. The flat screw 140 has a substantially columnar shape in which the height in the direction along the central axis is smaller than the diameter. The central axis of the flat screw 140 coincides with the rotation axis RX. A spiral groove 143 is formed around a central section 142 on a groove forming surface 141 of the flat screw 140 facing the barrel 150. The groove 143 communicates with a material introduction port 144 formed on a side surface of the flat screw 140. The material MR supplied from the material supply section 101 is supplied to the groove 143 through the material introduction port 144. The grooves 143 are formed by being separated from each other by ridge sections 145. FIG. 3 shows an example in which three grooves 143 are formed, but the number of grooves 143 may be one, two, or more. The grooves 143 are not limited to a spiral shape, may be helical or involute curvilinear, and may extend so as to draw an arc from the central section 142 to the outer periphery.

As illustrated in FIG. 2, a barrel heater 155 for heating the material MR supplied into the groove 143 of the flat screw 140 is embedded in the barrel 150. The temperature of the barrel heater 155 is controlled by the control section 50.

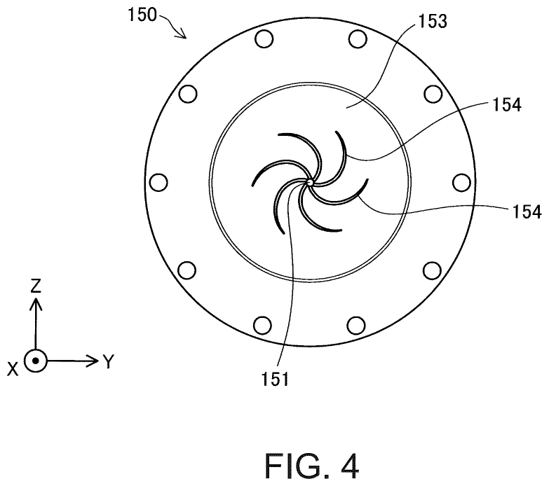

FIG. 4 is a schematic plan view of the barrel 150. The barrel 150 has a facing surface 153 that faces the groove forming surface 141 of the flat screw 140. A communication hole 151 penetrating the barrel 150 in the X direction is formed at the center of the facing surface 153. A plurality of guide grooves 154 connected to the communication hole 151 and extending in a spiral shape from the communication hole 151 toward the outer periphery are formed in the facing surface 153. The barrel 150 may not be provided with the guide groove 154.

The guide groove 154 may not be connected to the communication hole 151.

The material MR supplied to the groove 143 of the flat screw 140 flows along the groove 143 and the guide groove 154 by the rotation of the flat screw 140 while being plasticized between the flat screw 140 and the barrel 150 by the rotation of the flat screw 140 and the heating of the barrel heater 155, and is guided to the central section 142 of the flat screw 140. The molten material flowing into the central section 142 flows out from the communication hole 151 provided at the center of the barrel 150 to the first communication path 170. Note that in the molten material, all the substances constituting the molten material may not be plasticized. It is sufficient that the molten material is converted into a state having fluidity as a whole by plasticizing at least some kinds of substances among substances constituting the molten material.

The first communication path 170 is a hole extending linearly and formed in the component that is a block 180, which is a member arranged on the-X direction side of the barrel 150. In the present embodiment, the axis of the first communication path 170 is along the X direction. One end of the first communication path 170 is connected to the communication hole 151, and the other end of the first communication path 170 is connected to the material switching section 23. In other words, the first communication path 170 communicates with the plasticizing section 110. The molten material generated in the plasticizing section 110 passes through the first communication path 170 and flows out to the material switching section 23.

The fiber material introduction section 22 includes a fiber material supply section 210 and a second communication path 220. The fiber material supply section 210 supplies the fiber material FB to the material switching section 23. The fiber material supply section 210 includes an accommodation section 211, a transport roller 212, and a transport path 213. The fiber material FB wound around a reel is accommodated in the accommodation section 211. The transport rollers 212 are a pair of rollers that sandwich the fiber material FB supplied from the accommodation section 211. The transport rollers 212 are provided below the accommodation section 211. The transport rollers 212 rotate about their respective axes in a state of sandwiching the fiber material FB, and thus the fiber material FB is transported from the accommodation section 211 toward the material switching section 23. In the present embodiment, the direction along the axis of the transport roller 212 is the Y direction. The rotation of the transport roller 212 is controlled by the control section 50. The transport path 213 is a cylindrical member provided below the transport roller 212, and the fiber material FB sent out from the accommodation section 211 passes through the inside thereof. The fiber material supply section 210 may not include the transport path 213. The method of transporting the fiber material FB is not limited to the above-described method. For example, the fiber material FB may be transported from the accommodation section 211 toward the material switching section 23 by rotating a reel around which the fiber material FB is wound by a motor.

The second communication path 220 is a hole that is formed in the block 180 and that extends linearly. In the present embodiment, the axis of the second communication path 220 is along the Z direction. One end of the second communication path 220 is connected to the transport path 213, and the other end of the second communication path 220 is connected to the material switching section 23. In other words, the second communication path 220 communicates with the fiber material supply section 210. The fiber material FB supplied from the fiber material supply section 210 passes through the second communication path 220 and is transported to the material switching section 23. The axis of the second communication path 220 and the axis of the transport path 213 coincide with each other. In the present embodiment, the fiber material FB is transported from the accommodation section 211 to the material switching section 23 along the −Z direction so as not to be bent before reaching the material switching section 23.

The fiber material FB is formed of a fiber bundle in which a plurality of fibers is bundled. In the present embodiment, the fiber material FB has a configuration in which a plurality of carbon fibers are bundled by a bundling agent. The fiber material FB may be made of fiber material other than carbon fiber, and may be made of, for example, glass fiber. The fiber material FB may be formed of various fibers having a higher elastic modulus than the material MR. The fiber material FB may be formed of one fiber. The fiber material FB may be a fiber bundle in which a plurality of fibers is bundled or a material in which a single fiber is impregnated with a thermoplastic resin. The diameter of the fiber material FB may be, for example, 5 μm or more and equal to or less than the hole diameter of a nozzle opening 431 (to be described later). Here, the diameter of the fiber material FB corresponds to the maximum width dimension in a cross section orthogonal to the length direction of the fiber bundle constituting the fiber material FB.

A heat insulation material 250 is provided between the second communication path 220 and the plasticizing section 110. In the present embodiment, the heat insulation material 250 is a cylindrical member and is embedded in the block 180 so as to surround the second communication path 220. The heat insulation material 250 is made of, for example, ceramic, glass fiber, polytetrafluoroethylene (PTFE), or the like. The heat insulation material 250 may be provided between the second communication path 220 and the plasticizing section 110, and may be embedded between the second communication path 220 and the barrel 150 in the block 180, or may be provided between the block 180 and the barrel 150, for example.

The material switching section 23 is connected to the first communication path 170, the second communication path 220, and a flow path 410 (to be described later), and switches communication between the first communication path 170, the second communication path 220, and the flow path 410. The material switching section 23 includes a substantially columnar rotating member 310 that is rotatable about a rotation axis AX intersecting the axial direction of the flow path 410. The rotating member 310 is arranged inside a first hole 320 formed in the block 180. Here, the first hole 320 is a through hole penetrating the block 180 in the Y direction, and communicates with the first communication path 170, the second communication path 220, and the flow path 410. The first hole 320 may not be a through hole, but may be a hole having a bottom surface provided from the surface of the block 180 on the +Y direction side toward the-Y direction, or may be a hole having a bottom surface provided from the surface of the block 180 on the −Y direction side toward the +Y direction. The rotating member 310 is arranged inside the first hole 320 such that the rotation axis AX thereof is along the Y direction. The rotating member 310 is driven by a first drive section 330 under the control of the control section 50. The first drive section 330 is constituted by, for example, a stepping motor. The control section 50 controls the rotation angle of the rotating member 310 around the rotation axis AX using the first drive section 330. The detailed structure of the rotating member 310 will be described later.

The ejection section 24 includes the flow path 410, a suction section 420, a nozzle 430, and a nozzle heater 440. The flow path 410 is a hole extending linearly and formed on the −Z direction side of the material switching section 23 in the block 180. The axis of the flow path 410 extends along the Z direction. In other words, the axial direction of the flow path 410 is a direction along the axial direction of the second communication path 220. The axial direction of the flow path 410 intersects the axial direction of the first communication path 170. The flow path 410 is connected to the material switching section 23, and the molten material passing through the first communication path 170 and the fiber material FB passing through the second communication path 220 can pass through the flow path 410.

The nozzle 430 is arranged at the lower end of the block 180. The nozzle 430 communicates with the flow path 410 and ejects the molten material and the fiber material FB that passed through the flow path 410 from the nozzle opening 431 at the distal end toward the stage 30.

The nozzle heater 440 is arranged around a portion of the flow path 410 located in the vicinity of the nozzle 430. The nozzle heater 440 heats the molten material in the flow path 410 in the vicinity of the nozzle 430. The temperature of the nozzle heater 440 is controlled by the control section 50.

The suction section 420 suppresses a tailing phenomenon, in which the molten material drips like a thread from the nozzle opening 431, by temporarily suctioning the molten material in the flow path 410 when the molten material ejecting from the nozzle 430 is paused. The suction section 420 includes a branch path 421, a plunger 422, and a plunger drive section 423. The branch path 421 is a hole that is formed in the block 180 and that extends linearly, and is connected to the flow path 410. In the present embodiment, the direction in which the branch path 421 extends is the X direction. The plunger 422 is a shaft-shaped member and is arranged in the branch path 421. The plunger drive section 423 generates a driving force for instantaneously reciprocating the plunger 422 in the branch path 421 under the control of the control section 50. The plunger drive section 423 is configured by, for example, an actuator such as a solenoid mechanism, a piezoelectric element, or a motor. When temporarily interrupting the ejection of molten material from the nozzle 430, the control section 50 controls the plunger drive section 423 to instantaneously move the plunger 422 so that the distal end section of the plunger 422 shifts from the connecting section between the flow path 410 and the branch path 421 to a position retracted further into the branch path 421. By this, portion of the molten material in the flow path 410 is sucked into the branch path 421, and a negative pressure is generated in the flow path 410. When the fiber material FB is not present in the flow path 410 and only the molten material is present, the control section 50 moves the plunger 422 to suck the molten material in the flow path 410. The ejection section 24 may not include the suction section 420.

As shown in FIG. 1, the stage 30 is arranged at a position facing the nozzle opening 431 of the nozzle 430. The shaping surface 31 of the stage 30 facing the nozzle opening 431 is arranged so as to be parallel to the X and Y directions, that is, the horizontal direction. The stage 30 may be provided with a stage heater for suppressing rapid cooling of the molten material ejected onto the stage 30.

The movement mechanism 40 changes the relative position between the stage 30 and the nozzle 430 under the control of the control section 50. In the present embodiment, the position of the nozzle 430 is fixed, and the movement mechanism 40 moves the stage 30. The movement mechanism 40 is configured by a three axis positioner that moves the stage 30 in three axial directions of the X, Y, and Z directions by driving forces of three servo motors. In the present specification, unless otherwise specified, movement of the nozzle 430 means that the nozzle 430 or the ejection section 24 is relatively moved with respect to the stage 30.

Note that in another embodiment, instead of the configuration in which the stage 30 is moved by the movement mechanism 40, a configuration may be adopted in which the position of the stage 30 is fixed and the movement mechanism 40 moves the nozzle 430 with respect to the stage 30. A configuration in which the movement mechanism 40 moves the stage 30 in the Z direction and the nozzle 430 in the X and Y directions, or a configuration in which the movement mechanism 40 moves the stage 30 in the X and Y directions and the nozzle 430 in the Z direction, may be adopted. Even using these configurations, the relative positional relationship between the nozzle 430 and the stage 30 can be changed.

The control section 50 is a control device that controls operation of the entire three-dimensional molding device 10. The control section 50 is configured by a computer including a CPU 51, a storage device 52, and an input/output interface that inputs and outputs signals to and from the outside. The control section 50 functions to execute a molding process for molding a three-dimensional molded object by the CPU 51 executing a program or a command read on the main storage device. In the molding process, the control section 50 controls the plasticizing section 110, the fiber material supply section 210, the material switching section 23, the ejection section 24, and the movement mechanism 40 according to the molding data for molding the three-dimensional molded object, and molds the three-dimensional molded object including the molten material on the stage 30. In another embodiment, the control section 50 may be realized by a combination of a plurality of circuits for realizing at least portion of each function, instead of being constituted by a computer.

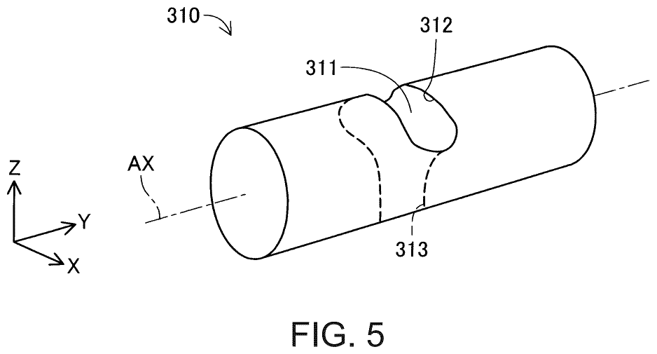

FIG. 5 is a perspective view of the rotating member 310. The rotating member 310 has a through hole 311 through which the molten material and the fiber material FB can pass. The through hole 311 is a hole penetrating the rotating member 310 in a direction intersecting the rotation axis AX. The through hole 311 has a first opening section 312 and a second opening section 313. The first opening section 312 can connect to the first communication path 170 and the second communication path 220. The second opening section 313 can connect to the flow path 410 and communicates with the first opening section 312. The opening area of the first opening section 312 is larger than the opening area of the second opening section 313. Here, the opening area of the first opening section 312 means the surface area of the outer peripheral surface of the rotating member 310 reduced by forming the first opening section 312. The same applies to the opening area of the second opening section 313. The rotating member 310 is also referred to as a butterfly valve.

The control section 50 controls the material switching section 23 to switch between a first mode, a second mode, a third mode, and a fourth mode. Specifically, the control section 50 rotates the rotating member 310 about the rotation axis AX to switch between the first mode, the second mode, the third mode, and the fourth mode. Here, the first mode is a mode in which the first communication path 170 and the flow path 410 communicate with each other and the second communication path 220 and the flow path 410 do not communicate with each other.

The second mode is a mode in which the first communication path 170 and the flow path 410 do not communicate with each other, and the second communication path 220 and the flow path 410 communicate with each other. The third mode is a mode in which the first communication path 170 and the second communication path 220 communicate with the flow path 410. The fourth mode is a mode in which neither the first communication path 170 nor the second communication path 220 communicates with the flow path 410.

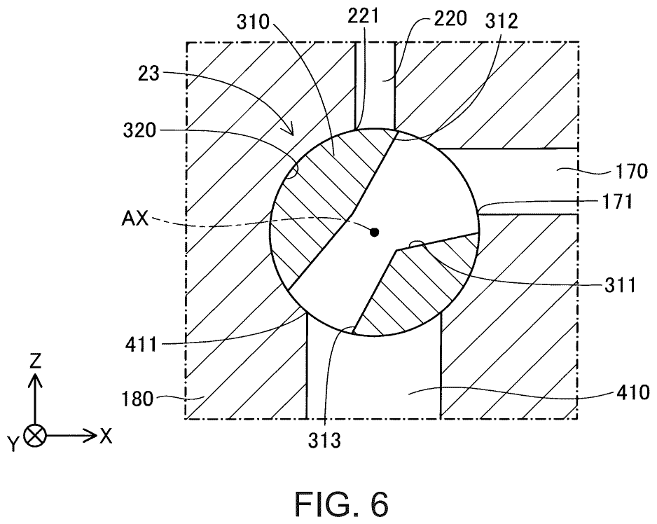

FIGS. 6 to 9 are diagrams illustrating the angular position of the rotating member 310 about the rotation axis AX in the four modes described above. Hereinafter, the end portion of the first communication path 170 connected to the material switching section 23 is referred to as an first communication path opening 171, the end section of the second communication path 220 connected to the material switching section 23 is referred to as an second communication path opening 221, and the end section of the flow path 410 connected to the material switching section 23 is referred to as an flow path opening 411.

FIG. 6 shows the angular position of the rotating member 310 about the rotation axis AX in the first mode. In the first mode, the control section 50 rotates the rotating member 310 to a position where at least a portion of the first communication path opening 171 and at least a portion of the first opening section 312 overlap each other, the second communication path opening 221 and the first opening section 312 do not overlap each other, and at least a portion of the flow path opening 411 and at least a portion of the second opening section 313 overlap each other. Therefore, in the first mode, the molten material in the first communication path 170 passes through the through hole 311 of the rotating member 310 and flows out to the flow path 410, but the fiber material FB in the second communication path 220 is not transported to the flow path 410. Therefore, in the first mode, only the molten material is ejected from the nozzle 430. The ejection amount of the molten material from the nozzle 430 is controlled by adjusting the amount of the molten material generated by the plasticizing section 110, for example, by the control section 50 controlling the rotation speed of the flat screw 140.

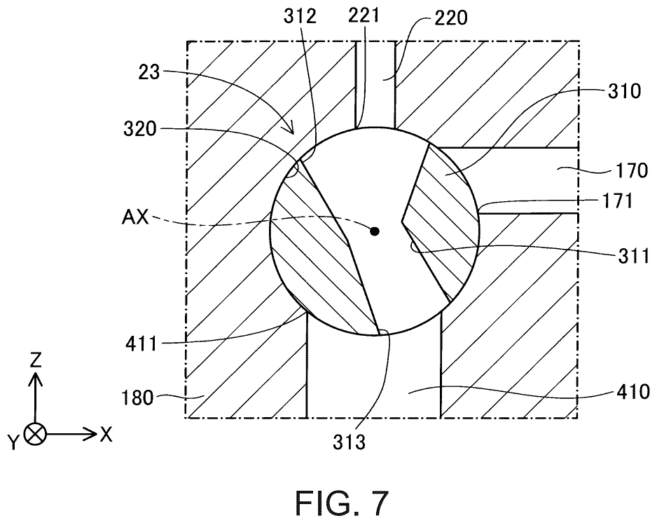

FIG. 7 shows the angular position of the rotating member 310 about the rotation axis AX in the second mode. In the second mode, the control section 50 rotates the rotating member 310 to a position where the first communication path opening 171 and the first opening section 312 do not overlap each other, a position where at least a portion of the second communication path opening 221 and at least a portion of the first opening section 312 overlap each other, and a position where at least a portion of the flow path opening 411 and at least a portion of the second opening section 313 each other. Therefore, in the second mode, the molten material in the first communication path 170 does not flow out to the flow path 410, but the fiber material FB in the second communication path 220 is transported to the flow path 410 via the through hole 311 of the rotating member 310. Therefore, in the second mode, only the fiber material FB is ejected from the nozzle 430. The ejection amount of the fiber material FB from the nozzle 430 is controlled by the control section 50 controlling the rotation speed of the transport roller 212.

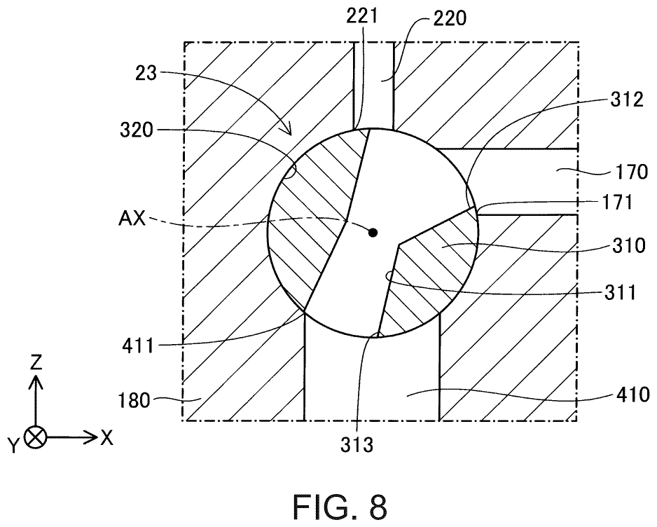

FIG. 8 shows the angular position of the rotating member 310 about the rotation axis AX in the third mode. In the third mode, the control section 50 rotates the rotating member 310 to a position where at least a portion of the first communication path opening 171 overlaps with at least a portion of the first opening section 312, at least a portion of the second communication path opening 221 overlaps with at least a portion of the first opening section 312, and at least a portion of the flow path opening 411 overlaps with at least a portion of the second opening section 313. Therefore, in the third mode, the molten material in the first communication path 170 passes through the through hole 311 of the rotating member 310 and flows out to the flow path 410, and the fiber material FB in the second communication path 220 is transported to the flow path 410 via the through hole 311 of the rotating member 310. Therefore, in the third mode, the molten material and the fiber material FB are ejected from the nozzle 430.

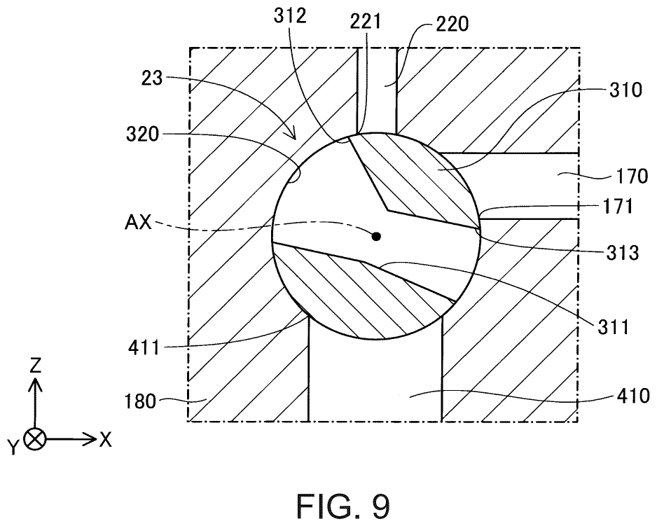

FIG. 9 shows the angular position of the rotating member 310 about the rotation axis AX in the fourth mode. In the fourth mode, the control section 50 rotates the rotating member 310 to a position where the first communication path opening 171 and the first opening section 312 do not overlap each other and the second communication path opening 221 and the first opening section 312 do not overlap each other. Therefore, in the fourth mode, the molten material in the first communication path 170 does not flow out to the flow path 410, and the fiber material FB in the second communication path 220 is not transported to the flow path 410. Therefore, in the fourth mode, neither the molten material nor the fiber material FB is ejected from the nozzle 430.

The control section 50 switches between the modes according to the molding data for molding the three-dimensional molded object. The control section 50 switches between the modes so that the fiber material FB is ejected to a portion of the three-dimensional molded object where the strength is to be improved, for example. The section of the three-dimensional molded object where the strength is desired to be improved is, for example, the outer enclosure of the three-dimensional molded object.

When the fiber material FB is to be cut, the control section 50 rotates the rotating member 310 from a position where at least a portion of the second communication path opening 221 and at least a portion of the first opening section 312 overlap each other to a position where the second communication path opening 221 and the first opening section 312 do not overlap each other. The control section 50 rotates the rotating member 310 from the position shown in FIG. 7 to the position shown in FIG. 6, for example. By this, the fiber material FB is bent in the vicinity of the second communication path opening 221, and thus the fiber material FB is cut. The case of cutting the fiber material FB is a case of changing from a state in which the fiber material FB is ejected from the nozzle 430 to a state in which the fiber material FB is not ejected from the nozzle 430.

For example, a case where the mode is switched from the second mode to the first mode or a case where the mode is switched from the third mode to the fourth mode corresponds to a case where the fiber material FB is cut.

According to the first embodiment described above, the control section 50 controls the material switching section 23 to switch modes among the first mode, in which the first communication path 170 communicated to the plasticizing section 110 communicates with the flow path 410 communicated to the nozzle 430, while the second communication path 220, which communicates with the fiber material supply section 210, does not communicate with the flow path 410, the second mode, in which the first communication path 170 does not communicate with the flow path 410, while the second communication path 220 communicates with the flow path 410, the third mode, in which both the first communication path 170 and the second communication path 220 communicate with the flow path 410, and the fourth mode, in which neither the first communication path 170 nor the second communication path 220 communicates with the flow path 410. Therefore, it is possible to switch between ejection of the molten material from the nozzle 430 and ejection of the fiber material FB.

In the present embodiment, the material switching section 23 includes the first opening section 312 that can be connected to the first communication path 170 and the second communication path 220, and the second opening section 313 that communicates with the first opening section 312 and that can be connected to the communication flow path 410. The opening area of the first opening section 312 is larger than the opening area of the second opening section 313. Therefore, compared to a case where the opening area of the first opening section 312 is smaller than the opening area of the second opening section 313, it is possible to easily switch between ejection of the molten material and ejection of the fiber material FB from the nozzle 430.

In the present embodiment, the material switching section 23 includes the rotating member 310 that is rotatable about the rotation axis RX, which intersects the axial direction of the flow path 410. The rotating member 310 has the through hole 311 through which the molten material and the fiber material FB can pass, and the through hole 311 has the first opening section 312 and the second opening section 313. Therefore, ejection of the molten material and ejection of the fiber material FB from the nozzle 430 can be switched by a single member.

In the present embodiment, in the first mode, the control section 50 rotates the rotating member 310 to a position where at least a portion of the first communication path opening 171 overlaps with at least a portion of the first opening section 312, the second communication path opening 221 does not overlap with the first opening section 312, and at least a portion of the flow path opening 411 overlaps with at least a portion of the second opening section 313. Therefore, in the first mode, only the molten material can be ejected from the nozzle 430.

In the present embodiment, in the second mode, the control section 50 rotates the rotating member 310 to a position where the first communication path opening 171 and the first opening section 312 do not overlap each other, at least a portion of the second communication path opening 221 and at least a portion of the first opening section 312 overlap each other, and at least a portion of the flow path opening 411 and at least a portion of the second opening section 313 overlap each other. Therefore, in the second mode, only the fiber material FB can be ejected from the nozzle 430.

In the present embodiment, in the third mode, the control section 50 rotates the rotating member 310 to a position where at least a portion of the first communication path opening 171 and at least a portion of the first opening section 312 overlap each other, at least a portion of the second communication path opening 221 and at least a portion of the first opening section 312 overlap each other, and at least a portion of the flow path opening 411 and at least a portion of the second opening section 313 overlap each other. Therefore, in the third mode, both the molten material and the fiber material FB can be ejected from the nozzle 430.

In the present embodiment, in the fourth mode, the control section 50 rotates the rotating member 310 to a position where the first communication path opening 171 and the first opening section 312 do not overlap each other and the second communication path opening 221 and the first opening section 312 do not overlap each other. Therefore, in the fourth mode, it is possible to prevent both the molten material and the fiber material FB from being ejected from the nozzle 430.

In the present embodiment, when the fiber material FB is to be cut, the control section 50 rotates the rotating member 310 from the position where at least a portion of the second communication path opening 221 and at least a portion of the first opening section 312 overlap each other to the position where the second communication path opening 221 and the first opening section 312 do not overlap each other. Therefore, the fiber material FB can be cut by rotating the rotating member 310.

In the present embodiment, the heat insulation material 250 is provided between the second communication path 220 and the plasticizing section 110. Therefore, it is possible to reduce the influence of the heat of the plasticizing section 110 on the fiber material FB passing through the second communication path 220.

In the present embodiment, the axial direction of the second communication path 220 is a direction along the axial direction of the flow path 410. Therefore, it is possible to reduce the risk that the fiber material FB is broken in the process of passing through the material switching section 23 from the second communication path 220 and being supplied to the flow path 410.

In addition, in the present embodiment, the nozzle heater 440 is arranged around a portion of the flow path 410 located in the vicinity of the nozzle 430. Therefore, since the molten material can be heated immediately before being ejected from the nozzle 430, the molten material can be more stably ejected from the nozzle 430.

### B. Other Embodiments

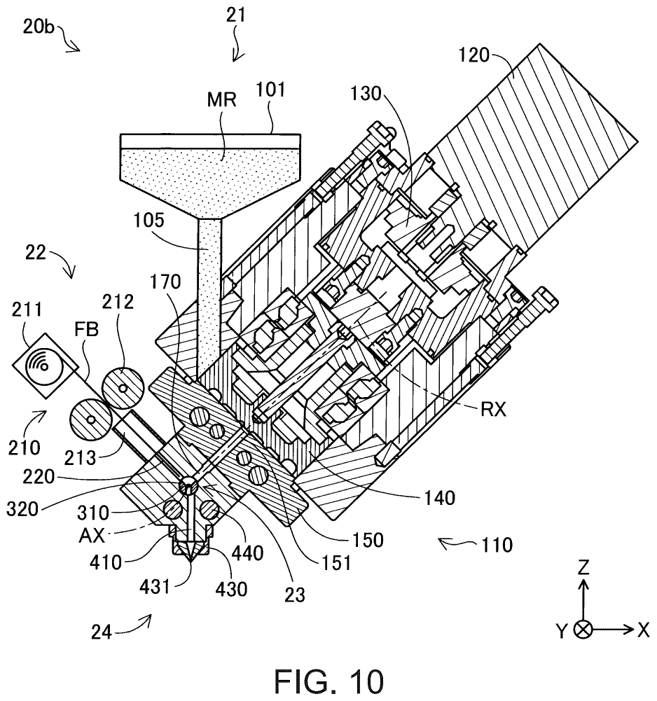

(B-1) In the above embodiment, the axial direction of the second communication path 220 is a direction along the axial direction of the flow path 410. In contrast, the axial direction of the second communication path 220 may not be along the axial direction of the flow path 410. FIG. 10 is an explanatory diagram illustrating an example of a schematic configuration of a molding section 20b in another embodiment. In the example illustrated in FIG. 10, the axial direction of the flow path 410 is a direction along the Z direction, and the axial direction of the second communication path 220 is a direction inclined by 45° from the Z axis in the XZ plane. The axial direction of the second communication path 220 is not limited to 45°, and may be inclined at any angle in a range of more than 0° and 90° or less from the Z axis in the XZ plane.
(B-2) In the above embodiment, the opening area of the first opening section 312 is larger than the opening area of the second opening section 313. In contrast, the opening area of the first opening section 312 may not be larger than the opening area of the second opening section 313.
(B-3) In the above embodiment, in the first mode, the control section 50 rotates the rotating member 310 to a position where at least a portion of the first communication path opening 171 and at least a portion of the first opening section 312 overlap each other, the second communication path opening 221 and the first opening section 312 do not overlap each other, and at least a portion of the flow path opening 411 and at least a portion of the second opening section 313 overlap each other. In contrast, in the first mode, the control section 50 may not rotate the rotating member 310 to a position where at least a portion of the first communication path opening 171 and at least a portion of the first opening section 312 overlap each other, the second communication path opening 221 and the first opening section 312 do not overlap each other, and at least a portion of the flow path opening 411 and at least a portion of the second opening section 313 overlap each other.
(B-4) In the above embodiment, in the second mode, the control section 50 rotates the rotating member 310 to a position where the first communication path opening 171 and the first opening section 312 do not overlap each other, at least a portion of the second communication path opening 221 and at least a portion of the first opening section 312 overlap each other, and at least a portion of the flow path opening 411 and at least a portion of the second opening section 313 overlap each other. In contrast, in the second mode, the control section 50 may not rotate the rotating member 310 to a position where the first communication path opening 171 and the first opening section 312 do not overlap each other, at least a portion of the second communication path opening 221 and at least a portion of the first opening section 312 overlap each other, and at least a portion of the flow path opening 411 and at least a portion of the second opening section 313 overlap each other.
(B-5) In the above embodiment, in the third mode, the control section 50 rotates the rotating member 310 to a position where at least a portion of the first communication path opening 171 and at least a portion of the first opening section 312 overlap each other, at least a portion of the second communication path opening 221 and at least a portion of the first opening section 312 overlap each other, and at least a portion of the flow path opening 411 and at least a portion of the second opening section 313 overlap each other. In contrast, in the third mode, the control section 50 may not rotate the rotating member 310 to a position where at least a portion of the first communication path opening 171 and at least a portion of the first opening section 312 overlap each other, at least a portion of the second communication path opening 221 and at least a portion of the first opening section 312 overlap each other, and at least a portion of the flow path opening 411 and at least a portion of the second opening section 313 overlap each other.
(B-6) In the above embodiment, in the fourth mode, the control section 50 rotates the rotating member 310 to a position where the first communication path opening 171 and the first opening section 312 do not overlap each other and the second communication path opening 221 and the first opening section 312 do not overlap each other. In contrast, in the fourth mode, the control section 50 may not rotate the rotating member 310 to a position where the first communication path opening 171 and the first opening section 312 do not overlap each other and the second communication path opening 221 and the first opening section 312 do not overlap each other.
(B-7) In the above embodiment, when the fiber material FB is to be cut, the control section 50 rotates the rotating member 310 from the position where at least a portion of the second communication path opening 221 and at least a portion of the first opening section 312 overlap each other to the position where the second communication path opening 221 and the first opening section 312 do not overlap each other. In contrast, the molding section 20 may include a cutting section, and the control section 50 may control the cutting section to cut the fiber material FB. The cutting section is configured by, for example, a cutter blade or a laser emitting mechanism.
(B-8) In the above embodiment, the heat insulation material 250 is provided between the second communication path 220 and the plasticizing section 110. In contrast, the heat insulation material 250 may not be provided between the second communication path 220 and the plasticizing section 110.
(B-9) In the above embodiment, the ejection section 24 includes the nozzle heater 440. In contrast, the ejection section 24 may not include the nozzle heater 440.
(B-10) In the above embodiment, the ejection amount of the molten material from the nozzle 430 is controlled, for example, by the control section 50 controlling the rotation speed of the flat screw 140. On the other hand, the ejection amount of the molten material from the nozzle 430 may be controlled by the control section 50 controlling the rotation angle of the rotating member 310 around the rotation axis AX.
(B-11) In the above embodiment, the first communication path 170 and the second communication path 220 are holes extending linearly. In contrast, at least one of the first communication path 170 and the second communication path 220 may be bent holes.
(B-12) In the above embodiment, in the fourth mode, the control section 50 rotates the rotating member 310 to a position where the first communication path opening 171 and the first opening section 312 do not overlap each other and the second communication path opening 221 and the first opening section 312 do not overlap each other. In contrast, in the fourth mode, the control section 50 may rotate the rotating member 310 to a position where neither the first opening section 312 nor the second opening section 313 overlaps the flow path opening 411.

### C. Other Forms

The present disclosure is not limited to the embodiments described above, but can be realized in various forms without departing from the scope of the present disclosure. For example, the present disclosure can also be realized by the following forms. The technical features in the above embodiments that correspond to the technical features in each aspect described below can be replaced or combined as appropriate to solve some or all of the issues of this disclosure or to achieve some or all of the effects of this disclosure. Unless the technical features are described as essential in the present specification, the technical features can be appropriately deleted.
(1) According to a first aspect of the present disclosure, the three-dimensional molding device is provided. The three-dimensional molding device includes a plasticizing section configured to plasticize at least a portion of a material containing thermoplastic resin to generate molten material; a fiber material supply section configured to supply fiber material; a first communication path communicating with the plasticizing section and configured to allow the molten material to pass through; a second communication path communicating with the fiber material supply section and configured to allow the fiber material to pass through; a flow path configured to allow passage of the molten material that passed through the first communication path and the fiber material that passed through the second communication path; a material switching section connected to the first communication path, to the second communication path, and to the flow path, and configured to switch communication state of the first communication path, the second communication path, and the flow path; a nozzle that communicates with the flow path and that ejects the molten material and the fiber material that passed through the flow path onto a stage; and a control section configured to control the plasticizing section, the fiber material supply section, and the material switching section to form a three-dimensional molded object including the molten material on the stage; wherein the control section is configured to control the material switching section to switch among a first mode in which the first communication path is in communication with the flow path and the second communication path is not in communication with the flow path, a second mode in which the second communication path is in communication with the flow path and the first communication path is not in communication with the flow path, a third mode in which both the first communication path and the second communication path are in communication with the flow path, and a fourth mode in which neither the first communication path nor the second communication path is in communication with the flow path.

According to such an aspect, it is possible to switch between the ejection of the molten material and the ejection of the fiber material from the nozzle.
(2) The above-described aspect may be such that the material switching section includes a first opening section configured to connect to the first communication path and to the second communication path, a second opening section communicating with the first opening section and configured to connect to the flow path, and an opening area of the first opening section is larger than an opening area of the second opening section.

According to this aspect, switching between the ejection of molten material and the ejection of fiber material from the nozzle can be performed more easily than in cases where the opening area of the first opening section has a smaller area than the opening area of the second opening section.
(3) The above-described aspect may be such that the material switching section includes a rotating member that is rotatable about a rotation axis intersecting an axial direction of the flow path, the rotating member includes a through hole configured to allow the molten material and the fiber material to pass through the rotating member, and the through hole includes the first opening section and the second opening section.

According to such an aspect, the ejection of the molten material and the ejection of the fiber material from the nozzle can be switched by one member.
(4) The above-described aspect may be such that, in the first mode, the control section causes the rotating member to rotate to a position where at least a portion of a first communication path opening, which is an end section of the first communication path connected to the material switching section, overlaps with at least a portion of the first opening section, where a second communication path opening, which is an end section of the second communication path connected to the material switching section, does not overlap with the first opening section, and where at least a portion of a flow path opening, which is an end section of the flow path connected to the material switching section, overlaps with at least a portion of the second opening section.

According to such an aspect, only the molten material can be ejected from the nozzle in the first mode.
(5) The above-described aspect may be such that, in the second mode, the control section causes the rotating member to rotate to a position where a first communication path opening, which is an end section of the first communication path connected to the material switching section, does not overlap with the first opening section, where at least a portion of a second communication path opening, which is an end section of the second communication path connected to the material switching section, overlaps with at least a portion of the first opening section, and where at least a portion of a flow path opening, which is an end section of the flow path connected to the material switching section, overlaps with at least a portion of the second opening section.

According to such the aspect, only the fiber material can be ejected from the nozzle in the second mode.
(6) The above-described aspect may be such that, in the third mode, the control section causes the rotating member to rotate to a position where at least a portion of a first communication path opening, which is an end section of the first communication path connected to the material switching section, overlaps with at least a portion of the first opening section, where at least a portion of a second communication path opening, which is an end section of the second communication path connected to the material switching section, overlaps with at least a portion of the first opening section and where at least a portion of a flow path opening, which is an end section of the flow path connected to the material switching section, overlaps with at least a portion of the second opening section.

According to such an aspect, in the third mode, both the molten material and the fiber material can be ejected from the nozzle.
(7) The above-described aspect may be such that, in the fourth mode, the control section causes the rotating member to rotate to a position where a first communication path opening, which is an end section of the first communication path connected to the material switching section, does not overlap with the first opening section and where a second communication path opening, which is an end section of the second communication path connected to the material switching section, does not overlap with the first opening section.

According to such an aspect, in the fourth mode, it is possible to prevent both the molten material and the fiber material from being ejected from the nozzle.
(8) The above-described aspect may be such that, when the fiber material is to be cut, the control section causes the rotating member to rotate from a position where at least a portion of a second communication path opening, which is an end section of the second communication path connected to the material switching section, overlaps with at least a portion of the first opening section, to a position where the second communication path opening does not overlap with the first opening section.

According to this aspect, the fiber material can be cut by rotating the rotating member.
(9) The above-described aspect may further include heat insulation material arranged between the second communication path and the plasticizing section.

According to such the aspect, it is possible to reduce the influence of the heat of the plasticizing section on the fiber material passing through the second communication path.
(10) The above-described aspect may be such that an axial direction of the second communication path is along an axial direction of the flow path.

According to such the aspect, it is possible to reduce the risk that the fiber material is broken in the process of passing through the material switching section from the second communication path and being supplied to the flow path.
(11) The above-described aspect may further include a nozzle heater that arranged around a portion of the flow path located near the nozzle.

According to such the aspect, since the molten material can be heated immediately before being ejected from the nozzle, the molten material can be more stably ejected from the nozzle.

What is claimed is:

1. A three-dimensional molding device comprising:
a plasticizing section configured to plasticize at least a portion of a material containing thermoplastic resin to generate molten material;
a fiber material supply section configured to supply fiber material;
a first communication path communicating with the plasticizing section and configured to allow the molten material to pass through;
a second communication path communicating with the fiber material supply section and configured to allow the fiber material to pass through;
a flow path configured to allow passage of the molten material that passed through the first communication path and the fiber material that passed through the second communication path;
a material switching section connected to the first communication path, to the second communication path, and to the flow path, and configured to switch communication state of the first communication path, the second communication path, and the flow path;
a nozzle that communicates with the flow path and that ejects the molten material and the fiber material that passed through the flow path onto a stage; and
a control section configured to control the plasticizing section, the fiber material supply section, and the material switching section to form a three-dimensional molded object including the molten material on the stage; wherein
the control section is configured to control the material switching section to switch among
a first mode in which the first communication path is in communication with the flow path and the second communication path is not in communication with the flow path,
a second mode in which the second communication path is in communication with the flow path and the first communication path is not in communication with the flow path,
a third mode in which both the first communication path and the second communication path are in communication with the flow path, and
a fourth mode in which neither the first communication path nor the second communication path is in communication with the flow path.

2. The three-dimensional molding device according to claim 1, wherein
the material switching section includes
a first opening section configured to connect to the first communication path and to the second communication path,
a second opening section communicating with the first opening section and configured to connect to the flow path, and
an opening area of the first opening section is larger than an opening area of the second opening section.

3. The three-dimensional molding device according to claim 2, wherein
the material switching section includes a rotating member that is rotatable about a rotation axis intersecting an axial direction of the flow path,
the rotating member includes a through hole configured to allow the molten material and the fiber material to pass through the rotating member, and
the through hole includes the first opening section and the second opening section.

4. The three-dimensional molding device according to claim 3, wherein
in the first mode, the control section causes the rotating member to rotate to a position
where at least a portion of a first communication path opening, which is an end section of the first communication path connected to the material switching section, overlaps with at least a portion of the first opening section,
where a second communication path opening, which is an end section of the second communication path connected to the material switching section, does not overlap with the first opening section, and
where at least a portion of a flow path opening, which is an end section of the flow path connected to the material switching section, overlaps with at least a portion of the second opening section.

5. The three-dimensional molding device according to claim 3, wherein
in the second mode, the control section causes the rotating member to rotate to a position
where a first communication path opening, which is an end section of the first communication path connected to the material switching section, does not overlap with the first opening section,
where at least a portion of a second communication path opening, which is an end section of the second communication path connected to the material switching section, overlaps with at least a portion of the first opening section, and
where at least a portion of a flow path opening, which is an end section of the flow path connected to the material switching section, overlaps with at least a portion of the second opening section.

6. The three-dimensional molding device according to claim 3, wherein
in the third mode, the control section causes the rotating member to rotate to a position
where at least a portion of a first communication path opening, which is an end section of the first communication path connected to the material switching section, overlaps with at least a portion of the first opening section,
where at least a portion of a second communication path opening, which is an end section of the second communication path connected to the material switching section, overlaps with at least a portion of the first opening section and
where at least a portion of a flow path opening, which is an end section of the flow path connected to the material switching section, overlaps with at least a portion of the second opening section.

7. The three-dimensional molding device according to claim 3, wherein
in the fourth mode, the control section causes the rotating member to rotate to a position
where a first communication path opening, which is an end section of the first communication path connected to the material switching section, does not overlap with the first opening section and
where a second communication path opening, which is an end section of the second communication path connected to the material switching section, does not overlap with the first opening section.

8. The three-dimensional molding device according to claim 3, wherein
when the fiber material is to be cut, the control section causes the rotating member to rotate
from a position where at least a portion of a second communication path opening, which is an end section of the second communication path connected to the material switching section, overlaps with at least a portion of the first opening section,
to a position where the second communication path opening does not overlap with the first opening section.

9. The three-dimensional molding device according to claim 1, further comprising:
heat insulation material arranged between the second communication path and the plasticizing section.

10. The three-dimensional molding device according to claim 1, wherein
an axial direction of the second communication path is along an axial direction of the flow path.

11. The three-dimensional molding device according to claim 1, further comprising
a nozzle heater that arranged around a portion of the flow path located near the nozzle.
